(19) United States
(12) Patent Application Publication
(10) Pub. No.: US 2005/0170891 A1
(43) Pub. Date: Aug. 4, 2005

(54) Venus system

(76) Inventors: Kwang Hyun Shim, Taejon (KR); Yung Woo Jung, Taejon (KR); Bum Hyun Lim, Sungnam (KR); Jaeyong Chung, Taejon (KR); Il Kyu Park, Taejon (KR); Byoung Tae Choi, Taejon (KR)

Correspondence Address: JACOBSON, PRICE, HOLMAN & STERN;PROFESSIONAL LIMITED LIABILITY COMPANY, 400 Seventh Street, N.W., Washington, DC, 20004, US

(21) Appl. No.: 10/860,304

(22) Filed: Jun. 4, 2004

(30) Foreign Application Priority Data
Dec. 24, 2003 (KR) 2003-96970

(51) Int. Cl. G06F 17/00; A63F 9/24; G06F 19/00

(52) U.S. Cl. 463/42

(57) ABSTRACT

A VENUS (Virtual Environment Network User Simulator) system, including: a VC (Virtual Client) agent for managing a plurality of VCs and providing a monitoring result; a server observer for transmitting a state of a server system by a request or periodically; a client observer for transmitting a state of a client system by a request or periodically; a testing game client for transmitting a state of an application program by using an API (Application Program Interface) provided from an observer library; a testing game server cluster for transmitting a state of an application program using the API provided from the observer library; and a CES (Central Engineering Station) for receiving an input from a user to setup a simulation environment, managing the VC agent, monitoring a network state and the state of the server system through the server observer, and monitoring the state of the client system through the client observer.

### BACKGROUND OF THE INVENTION

1. Field of the Invention

The present invention relates to a VENUS (Virtual Environment Network User Simulator) system, and more particularly, to a VENUS system for allowing a virtual environment to be consolidated and tested such that a stability of a large-scaled online game server is measured.

2. Description of the Related Art

Recently, the advances in simulation technology offer the potential for the development of cost-effective, highly reliable networked virtual environment. Especially, a study for the simulation using a discrete event is under vigorous development.

A discrete event structure is a way of consolidating a dispersive computing environment having a computer connected through a network and progressing the simulation. The simulation progress uses an event such as a message. This discrete event structure can solve the synchronization problem which can be a single point of failure in most of the distributed computing simulations since a simulation server synchronizes with each client and transmits the event messages. Simulation execution time has a characteristic that it depends on the number of the event generated during the simulation.

The research area for testing stability after generating certain amount of load belongs to the load testing area from a software engineering's point of view. As a recent study for a method of improving performance and stability on a server side of a client-server structure model, a study for a method of utilizing a virtual client is in progress.

A study is in progress where the virtual client similar with an actual client is created and then a request is transmitted to the server at this time to measure an execution time for which the server processes the request and to use the measured time as a criterion of a performance of the server.

Generally, although it is required to provide the simulation situation that several hundreds or thousands of client users participate and play the game, the number of virtual users that can be simulated by one host is limited to a hardware performance of the host. Thus, a system structure is required to integrate, control and monitor a plurality of virtual user hosts such that the simulation can be provided for a large number of users. Since several hundreds or thousands of users using the online game respectively have network environments (a hardware performance, a latency and the like) different from one another, remote hosts variously distributed over the network do need to be utilized as simulators. For this, a system for integrating, controlling and managing each of the simulators is required.

Further, in order to allow the game developers to actually devote themselves to a development of the game client, a maximal convenience should be provided when the virtual client simulator for a server test is embodied.

### SUMMARY OF THE INVENTION

A technical problem to be solved in the present invention can be mainly classified into several subjects.

First, an extensible structure should be provided such that an environment having a large-scaled simultaneous or synchronous connection user can be simulated when an online game simulation is performed with the large-scaled simultaneous or synchronous connection user. The present invention secures an extensibility of a VENUS system by using a dual management structure. The dual management structure of the present invention is a structure having a plurality of virtual clients (VCs) provided for one computer, allowing a plurality of VC agents to manage the plurality of VCs, and allowing a central management program called a Central Engineering Station (CES) to manage the plurality of VC agents. In the structure considering the extensibility, a simulation environment where the large-scaled virtual client is required can be easily consolidated. Further, the present invention includes a function of allowing the virtual client to be dynamically controlled to have an appropriate number depending on a computer performance for operating the virtual client such that the virtual client can exactly apply a load to a testing game server cluster.

Second, in order to test an online game system, various necessary simulation environments should be supported. In the present invention, information interchanged between the testing game server cluster and the VC is primarily generalized such that the online game system supports various simulation environments. On basis of the generalized information, the present invention defines and embodies a function supportable in a simulation of the online game system.

Third, the VENUS system should be able to use the VC to simulate an action of the game client specialized for each game. For this, the present invention provides the VC engine, and the VC engine is embodied as a communication protocol and a library. When the game client is modified into the VC, the VC engine provides the communication protocol and the library that can be associated with the VENUS system, and allows the clients specialized for each game to be associated with the VENUS system.

Fourth, a data transmission structure should be provided for allowing data within the game as well as a performance of a management-target system to be monitored when the online game system is monitored. Further, the collected monitoring data should be stored for a subsequent analysis. The VENUS system is designed to monitor not only simple information on performance, but also information within the game while the game simulation is progressed. In order to embody the function, a flexible communication protocol is embodied to allow various data to be transmitted and received according to a user's need.

Accordingly, the present invention is directed to a VENUS system, which substantially obviates one or more problems due to limitations and disadvantages of the related art.

It is an object of the present invention to provide a VENUS system for allowing a beta testing process performed for developing an online game to be simulated.

Additional advantages, objects, and features of the invention will be set forth in part of the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a VENUS (Virtual Environment Network User Simulator) system, including: a VC (Virtual Client) agent for managing a plurality of VCs and providing a monitoring result; a server observer for transmitting a state of a server system by a request or periodically; a client observer for transmitting a state of a client system by a request or periodically; a testing game client for transmitting a state of an application program by using an API (Application Program Interface) provided from an observer library; a testing game server cluster for transmitting a state of an application program using the API provided from the observer library; and a CES (Central Engineering Station) for receiving an input from a user to setup a simulation environment, managing the VC agent, monitoring the state of the network and the server system through the server observer, and monitoring the state of the client system through the client observer.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a view illustrating a construction of a VENUS system according to one embodiment of the present invention;

FIG. 2 is a view illustrating a system extension of a VENUS system according to one embodiment of the present invention of FIG. 1;

FIG. 3 is a view illustrating a summary of a protocol exchanged between a VC (Virtual Client) agent and a CES (Central Engineering Station) of FIG. 1;

FIG. 4 is a view illustrating a structure of a VENUS Identification (VID) used for managing a VENUS system of FIG. 3;

FIG. 5 is a view illustrating a summary of a protocol related with a movement of an avatar among protocols of FIG. 3;

FIG. 6 is a view illustrating a summary of a protocol related with a characteristic of an avatar among protocols of FIG. 3;

FIG. 7 is a view illustrating a summary of a protocol used between a VC and a VC agent of FIG. 1; and

FIG. 8 is a view illustrating a summary of a protocol exchanged to a CES from a testing game client and a testing game server cluster of FIG. 1.

### DETAILED DESCRIPTION OF THE INVENTION

Reference will now be made in detail to the preferred embodiments of the present invention, examples of which are illustrated in the accompanying drawings.

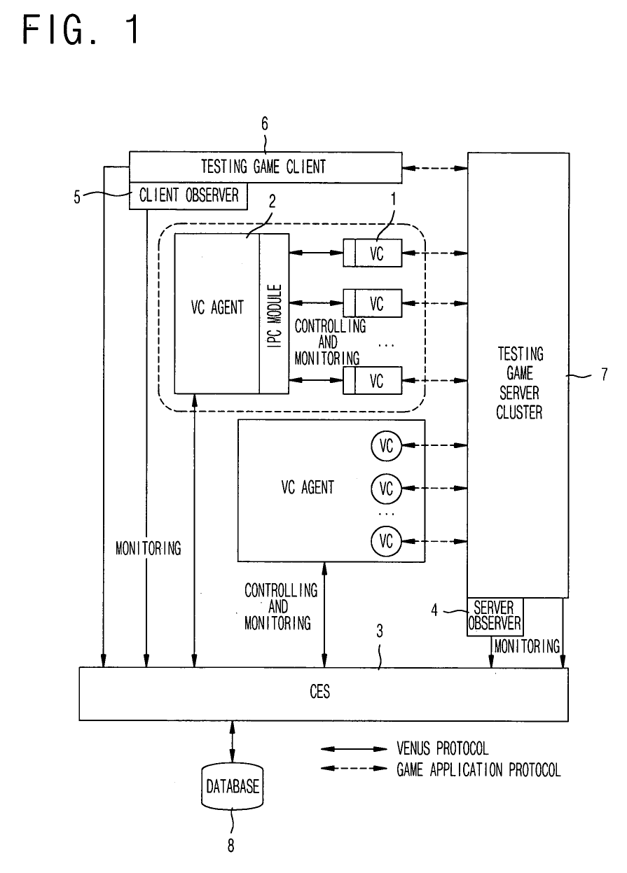

FIG. 1 is a view illustrating a construction of a VENUS system according to one embodiment of the present invention.

As shown in FIG. 1, the VENUS system according to one embodiment of the present invention includes a VC (Virtual Client) agent 2 for managing a plurality of VCs (Virtual Clients) 1 and providing a monitoring result; a server observer 4 for transmitting a state of a server system by a request or periodically; a client observer 5 for transmitting a state of a client system by a request or periodically; a testing game client 6 for transmitting a state of an application program by using an API (Application Program Interface) provided from an observer library; a testing game server cluster 7 for transmitting a state of an application program by using the API provided from the observer library; and a CES (Central Engineering Station) 3 for receiving an input from a user to setup a simulation environment, managing the VC agent 2, monitoring a network state and the state of the server system through the server observer, and monitoring the state of the client system through the client observer 5.

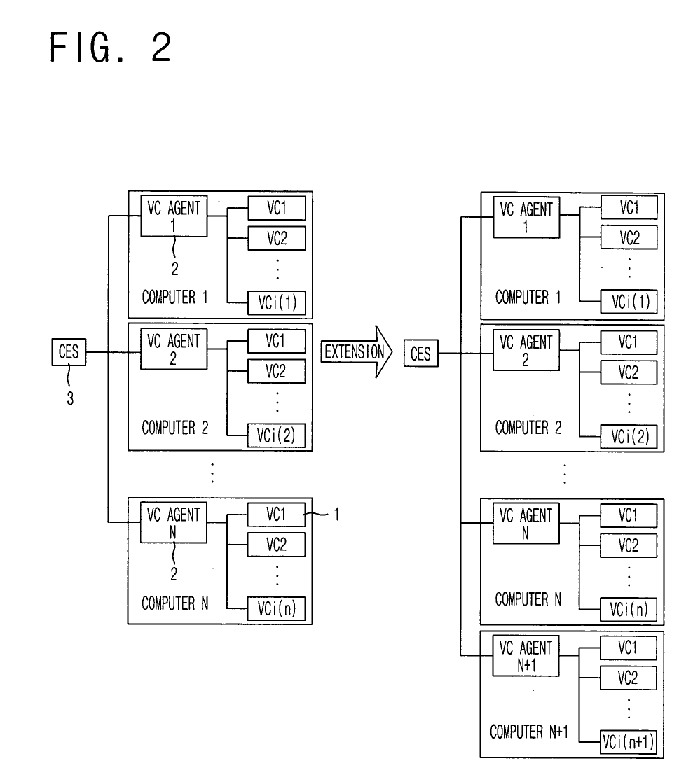

An operation of the VENUS system according to an embodiment of the present invention is in detail described in the following with reference to the attached FIGS. 2 to 8.

First of all, the VC 1 is a module for substituting for one game client (a client program is actually used by a game player), and is controlled by an external system, not a game player, unlike an actual game client. According to need, the VC 1 includes one independent execution module or library form, and communicates with the testing game server cluster 7 (game server, log-in server and the like) while participating in and progressing the game. The VC 1 and the game client should not be distinguished in the testing game server cluster 7. Particularly, the VC 1 is not provided from the VENUS system, and is developed by actively utilizing an actual game client program adapted to the game. For this, the VENUS system provides a VC engine. Further, the actual number of VC in one client host is depending on a hardware and network specification of one client host.

The VC agent 2 is executed as a daemon program in the client host while managing (creating, controlling, deleting, monitoring and the like) a plurality of VCs 1. The VC agent 2 receives and processes a command from the CES 3, and provides the monitoring result for the CES 3. Only one VC agent 2 is executed per one host.

The CES 3 receives the input from the user (game developer or game tester) to setup a simulation environment, manages (sets, controls, monitors and the like) the VCs 2 and monitors the network state and the state of the server system through the server observer 4, and monitors the state of the client system through the client observer 5. Additionally, the CES 3 allows the user to compare and analyze the simulation result and stores its result in a database 8.

The server observer 4 is executed as the daemon program in a testing game server cluster 7 while transmitting the state (an occupation rate of a CPU, a used amount of the network, and the like) of the server system to the CES 3 by the request or periodically.

The client observer 5 is executed as the daemon program in a testing game client 6 while transmitting the state (the occupation rate of the CPU, the used amount of the network, and the like) of the client system to the CES 3 by the request or periodically. All of the server observer 4 and the client observer 5 monitor the system state to transmit it to the CES 3 while the testing game client 6 and the testing game server cluster 7 respectively provide state information specialized for a target online game for the CES 3. The user (game developer) should determine as to whether any state information is provided. For this, the developer (VENUS developer) provides the user (game developer) with the observer library, and the user embodies the testing game client 6 and the testing game server cluster 7 by using an existing retained development program (the game client, the game server cluster)and observer library.

The testing game client 6 is a program additionally having a part for transmitting a state of an application program by using the API provided from the observer library in the game client.

The testing game server cluster 7 is programs additionally having a part for transmitting the state of the application program by using the API provided from the observer library in the game server cluster.

The database 8 is used to store various information obtained through the simulation.

FIG. 2 is a view illustrating a system extension of the VENUS system according to one embodiment of the present invention.

The VENUS system according to an embodiment of the present invention has a limit in a system test using a small number of VCs 1 operated in one computer since the online game system is simulated in the environment having a plurality of simultaneous or synchronous connections. In order to operate the plurality of VCs 1, a structure for managing the plurality of VCs 1 using the VC agent 2 and the CES 3 is designed.

As shown in FIG. 2, if a total number of the VC 1 operated in one computer i is expressed as f(i) (herein, i=1, . . . , N), a total number T of the VC 1 operable in the VENUS system is as below.

$$T = {\sum }_{i = 1}^{N} f ( i )$$

Through the dual management structure, the VENUS system has an advantage in that the extensibility is provided, and the large-scaled online game simulation environment can be consolidated.

The VENUS system is generalized such that the online game systems different from one another can reuse a function related with the simulation. Particularly, a control command of the VC 1 differs every contents of the game, but is generally embodied as the protocol.

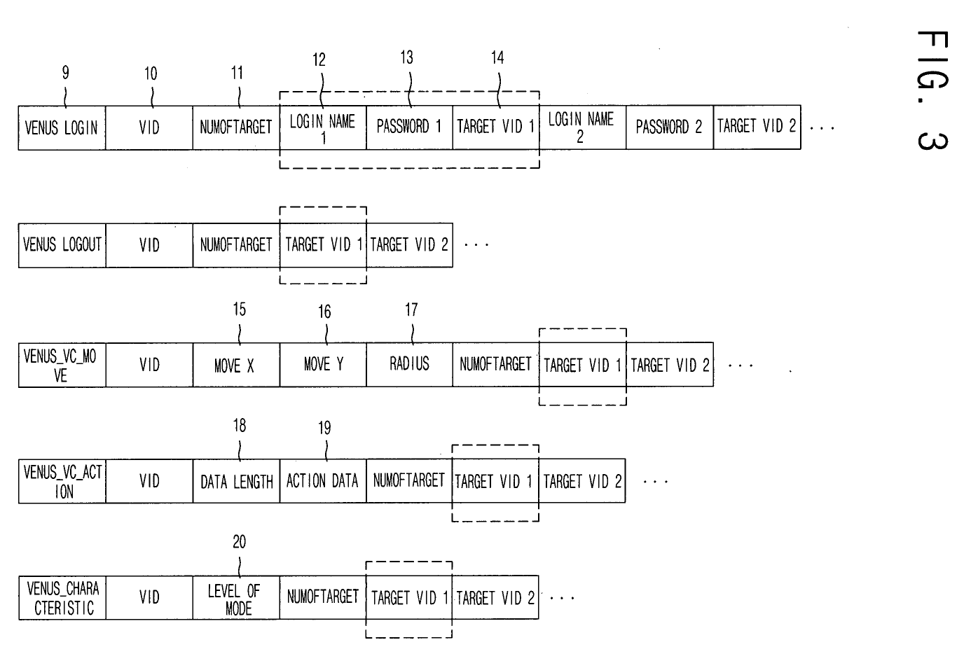

FIG. 3 illustrates a detailed packet form of the protocol embodied for use in a control of the VC 1.

In FIG. 3, a packet identification 9 and a VENUS identification (VID) 10 of a packet transmitter are fields commonly used in the packet used for the CES 3, the VC agent 2, the testing game client 6 and the testing game server cluster 7.

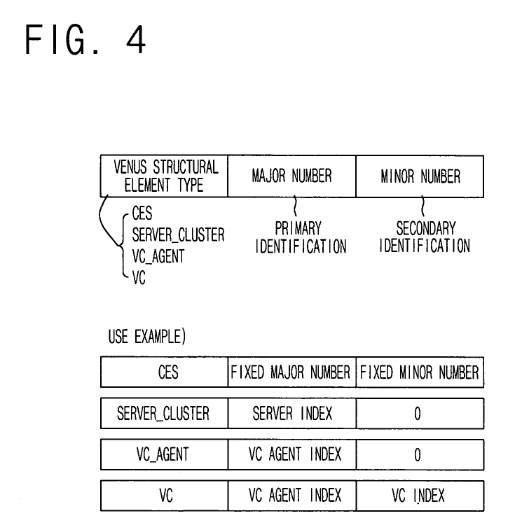

FIG. 4 is a view illustrating contents and a use example of the VENUS IDentification (VID) of FIG. 3.

The VENUS system can distinguish each of structural elements by using the VENUS identification (VID). Login and logout function used in the online game is a user authentication process. Login and logout function is essential for the online game system. Through authentication process, an online game system user is confirmed, and an access is granted to data and contents necessary for progressing the game. The contents required for the authentication process are a login name and a login password.

In FIG. 3, a “login name” 12, a “login password” 13 and a “target VID” 14 of the VC 1 existing in the VC agent 2 is a main content of a protocol packet related with the login. The “login name” 12, the “login password” 13 and the “target VID” 14 are data needing for a specific VC 1 having one data group existing in the VC agent 2 to login to the testing game server cluster 7. In FIG. 3, a “NumofTarget” 11 represents a total number of the VC 1 to be login to a corresponding packet. Similarly, the packet taking charge of logout can terminate a service connection for the specific VC 1 by using the identification. A movement protocol is devised for performing a function of moving the avatar existing within the game to a specific area. In FIG. 3, “Move X”, “Move Y” and “Radius” 15, 16 and 17 represent main information on a movement command necessary for embodying the above function. The “Move X” and “Move Y” 15 and 16 represent a 2-dimensional coordinate, and the “Radius” 17 is radius information for designating the specific area from the coordinate of the “Move X” and “Move Y” 15 and 16.

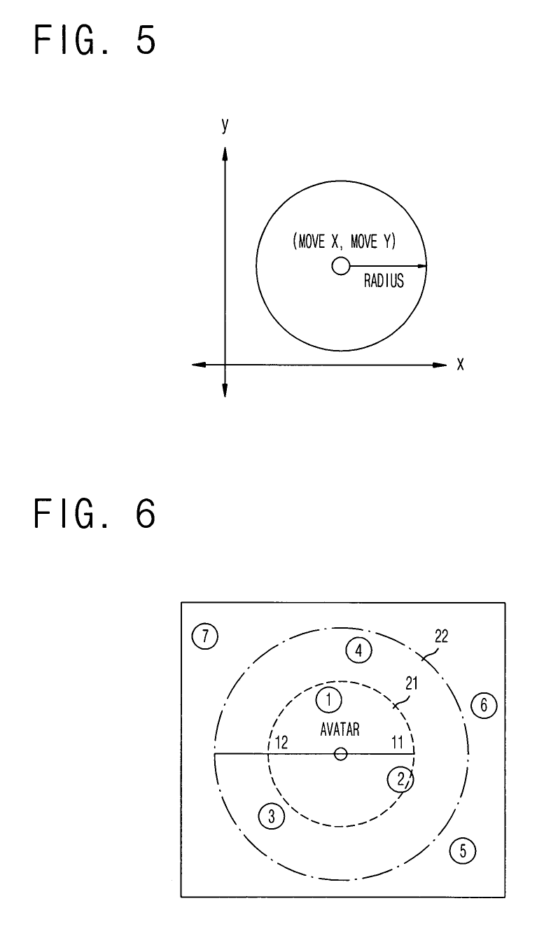

FIG. 5 is to express meanings of the “Move X”, “Move Y” and “Radius” 15, 16 and 17 in the drawing.

Various tests are required to allow the VC 1 to progress the game while performing a necessary function. Accordingly, the avatar should take various actions so as to perform the test. However, there is a drawback in subdivision and definition since the game client performs a necessary definition action of itself every online game system. Accordingly, in the VENUS system, an operation other than the content related with a movement of the avatar is defined as the action to embody the function.

Proper action information on the game transmitted between the VC 1 and the testing game server 7 is stored in a “Action Data” 19 shown in FIG. 3, and a length of the action information is stored in a “Data Length” 18 to be transmitted to the VC agent 2. If so, the VC agent 2 transmits the action information to the VC 1 to send a proper command of the game to the testing game server cluster 7. A protocol is also devised to designate a game play characteristic of the avatar when the game simulation is progressed. A “Level of Mode” 20 shown in FIG. 3 is core information for determining a performance of a specific work for an object entering from the position of the avatar into the specific area.

FIG. 6 exemplifies a battle belligerence of the avatar. At this time, the “Level of Mode” 20 shown in FIG. 3 has a long distance from an enemy to itself in comparison with the battle belligerence, and a battle can be generated or not depending on a area of circle. For example, since an area 21 shown in FIG. 6 has less probability of generating the battle than an area 22, it can be allowed to have less belligerence in case that the avatar is set to the area 21.

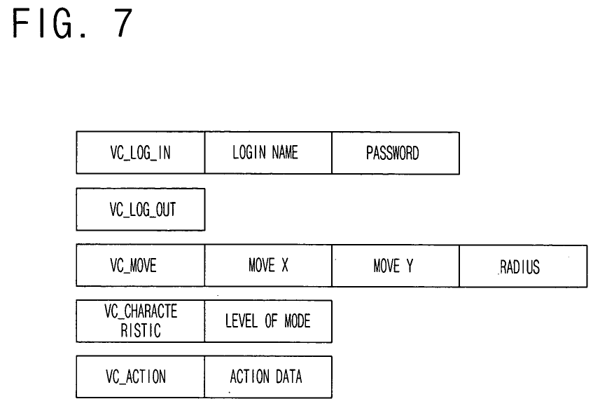

A type of information exchanged between the VC 1 and the VC agent 2 is as shown in FIG. 7. FIG. 7 shows the protocol that the protocol exchanged between the VC agent 2 and the CES 3 of FIG. 3 is transformed into and is used between the VC 1 and the VC agent 2. Each function has a similar meaning. A difference between FIG. 7 and FIG. 4 is that a multiple operation capability is provided in FIG. 4, but the multiple operation capability is deleted from FIG. 7 due to its unnecessaries.

In the VENUS system, two kinds of data are mainly used in view of the monitoring and management of the system.

The first is general performance index provided for each structural element of the VENUS system, and the second is information on the game itself that the user desires to monitor. The performance index represents consumption of amount of a processor, physical memory, virtual memory, network resources, and the like of the computer for operating the VENUS system. The VENUS system determines the number of the VC 1 on basis of the performance index of the VC agent 2, and performs the dynamic management. That is, even though the number of the VC 1 is initially increased through the simple work, if an operation amount is increased during the simulation to cause the performance of the VC agent 2 to be insufficient for maintaining an existing setup, the appropriate number of the VC 1 can be again calculated such that the number of the VC 1 is controlled to provide an acceptable amount. Further, the performance of the game server cluster can be measured.

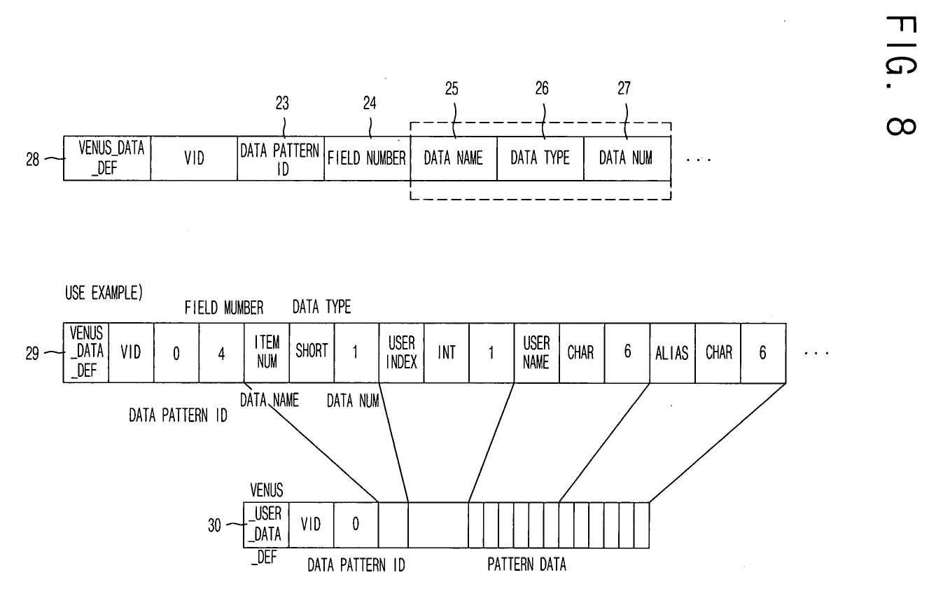

The performance index can be easily embodied as information formalized. However, since a size of information that the user desires to monitor cannot be acknowledged in case of internal information on a game server cluster or the game client, the present invention provides the flexible protocol for supporting variable information like FIG. 8. FIG. 8 shows an initialization protocol and a use example of the flexible protocol.

In FIG. 8, a “VENUS_DATA_DEF” 28 is a packet of data selection for the flexible protocol and is transmitted to the CES 3 in the testing game client 6 and the testing game server cluster 7. In case that the CES 3 receives the “VENUS_DATA^{—}DEF” 28, it makes a database table in the database 8 by using “Data Pattern ID”, “Field Number”, “Data Name”, “Data Type” and Data Num” 23, 24, 25, 26 and 27 and prepares data storage. The “VENUS_DATA_DEF” 29 and “VENUS_USER_DATA_DEF” 30 show the use examples of the flexible protocol. If the packet of the form such as the “VENUS_DATA_DEF” 29 enters into the CES 3 as an initialization command, the packet entering for storage is determined such as the “VENUS_USER_DATA_DEF” 30.

As described above, in case that the present invention is applied to the development of the large-scaled online game, a resource needed for the game development, but consumed for the existing ineffective beta test can be minimized.

Further, various simulations are previously performed to secure the system stability, and further a capacity of the simple online game server for accepting the user is not only measured, but also a maintenance of the online game system through the flexible data management protocol can be easily achieved.

Further, small and medium-sized enterprises which do not perform the beta test of the online game system for a long period can use the VENUS system to consolidate a stable and effective online game system with a low cost. Therefore, they can produce a higher quality of product.

The present invention can improve the beta test process using several thousands of the actual users that is performed for performance improvement and stability verification after being initially developed in the online game requiring a high reliability. Since the beta test period consumes a long period and a high cost, a productivity of the online game system can be improved (reduction in the development cost and reduction in the period) in case that the test environment of the online game system using the virtual user according to the present invention is used.

It will be apparent to those skilled in the art that various modifications and variations can be made in the present invention. Thus, it is intended that the present invention covers the modifications and variations of this invention provided they come within the scope of the appended claims and their equivalents.

1. A VENUS (Virtual Environment Network User Simulator) system, comprising:
a VC (Virtual Client) agent for managing a plurality of VCs and providing a monitoring result;
a server observer for transmitting a state of a server system by a request or periodically;
a client observer for transmitting a state of a client system by a request or periodically;
a testing game client for transmitting a state of an application program by using an API (Application Program Interface) provided from an observer library;
a testing game server cluster for transmitting a state of an application program using the API provided from the observer library; and
a CES (Central Engineering Station) for receiving an input from a user to setup a simulation environment, managing the VC agent, monitoring a network state and the state of the server system through the server observer, and monitoring the state of the client system through the client observer.

2. The VENUS system of claim 1, further comprising a database for storing simulation-targeted performance information and user definition information.

3. The VENUS system of claim 1, wherein the VC and the VC agent use a generalization protocol to control various VCs.

4. The VENUS system of claim 1, wherein the VC agent and the CES use the generalization protocol to control various VCs.

5. The VENUS system of claim 1, wherein the CES and the testing game client use a flexible protocol to transmit user definition data.

6. The VENUS system of claim 1, wherein the CES and the testing game server cluster use the flexible protocol to transmit the user definition data.

7. The VENUS system of claim 1, wherein a limit for applying a load to the testing game server cluster is dynamically calculated depending on a performance of the VC agent, and is controlled according to need.
